(19) United States
(12) Patent Application Publication
(10) Pub. No.: US 2002/0120617 A1
(43) Pub. Date: Aug. 29, 2002

(54) Database retrieving method, apparatus and storage medium thereof

(75) Inventors: Masaharu Yoshiyama, Kawasaki (JP); Katsushi Wakiyama, Kawasaki (JP)

Correspondence Address: Patrick G. Burns, Esq., GREER, BURNS & CRAIN, LTD., Suite 2500, 300 South Wacker Drive, Chicago, IL, 60606, US

(73) Assignee: FUJITSU LIMITED

(21) Appl. No.: 09/911,784

(22) Filed: Jul. 24, 2001

(30) Foreign Application Priority Data
Feb. 28, 2001 (JP) 2001-053884

(51) Int. Cl. G06F 7/00

(52) U.S. Cl. 707/3

(57) ABSTRACT

A comparison between a cost required when retrieval is performed after an index corresponding to a retrieval condition is generated and a cost required when entire retrieval is performed is made. If the cost required when the entire retrieval is performed is higher, it is determined whether or not an applicable index exists among already generated indexes. If an applicable index does not exist, an index corresponding to the retrieval condition is generated. A database is then retrieved by using the generated index.

### BACKGROUND OF THE INVENTION

1 Field of the Invention

The present invention relates to a relational database retrieving method, and more particularly, to a database retrieving method retrieving a database by generating a dynamic index suitable for a particular retrieval process when a retrieval process under a particular condition, that is, an irregular retrieval process is performed, and to a storage medium storing the method.

2 Description of the Related Art

In recent years, there has been a demand for speeding up not only regular retrieval for frequently executed operations, but also an irregular retrieval process, as a retrieval method for a relational database, a retrieval condition of which differs every time like a data warehouse.

Manipulations that a user performs for a database fall into 4 types such as data registration, retrieval, update, and deletion. These manipulation types are collectively called data manipulations, and a DBMS (DataBase Management System) is used as a system performing data manipulations.

A language for performing data manipulations with a DBMS is called a DML (Data Manipulation Language), and one type of the DML is an SQL (Structured Query Language).

Conventionally, when a database is retrieved with an SQL language, retrieval is performed after an index required for the retrieval is generated before hand. With regular retrieval, a generated index is used every retrieval, thereby speeding up database retrieval.

In the meantime, when irregular retrieval a retrieval condition of which differs every time is performed, an already generated index cannot be used in many cases. Therefore, to quickly perform irregular retrieval, an index required for the retrieval is predicted, and an index corresponding to every retrieval condition is generated, or retrieval using entire scanning is performed without using an index. Additionally, if an index is generated, an index corresponding to data is updated each time the data within a database is updated or deleted.

If a suitable index required for retrieval does not exist in database retrieval using an SQL language as described above, an access to the database results in entire scanning. With the entire scanning, a lot more time and CPU resources are consumed in comparison with an access using an index.

To overcome this problem and speed up retrieval, an index matching a retrieval condition must be generated beforehand. That is, for irregular retrieval, an index matching a particular retrieval condition must be generated for each condition, which causes the disk resources for storing indexes to be consumed much. Furthermore, many indexes are generated, leading to a degradation of access performance when data is updated, added, or deleted.

### SUMMARY OF THE INVENTION

The present invention was developed in view of the above described problems, and aims at speeding up database retrieval by dynamically generating an index required to retrieve a database or by reusing an already generated index, if there are no indexes or if indexes are not available unchanged although they exist, at reducing the resources for storing generated indexes, and at preventing access performance from being degraded when a database is retrieved.

A first database retrieval method according to the present invention comprises: making a comparison between a cost required when retrieval is performed after an index corresponding to a retrieval condition is generated and a cost required when entire retrieval is performed; generating an index corresponding to the retrieval condition if the cost required when the entire retrieval is performed is higher as a result of the cost comparison; and retrieving a database by using the generated index.

The first database retrieval method produces great effects especially when irregular retrieval is performed. If the cost required when the entire retrieval is performed is higher, a required index is dynamically generated and reused later in an applicable case, thereby speeding up a retrieval process without requiring the disk resources for storing many indexes.

A second database retrieval method according to the present invention comprises: making a comparison between a cost required when retrieval is performed after an index corresponding to a retrieval condition is generated and a cost required when entire retrieval is performed; determining whether or not an index which satisfies a condition wider than the retrieval condition exists among already generated indexes, if the cost required when the entire retrieval is performed is higher as a result of the cost comparison; generating an index which satisfies only the retrieval condition by using the index if the index which satisfies the wider condition exists; and retrieving a database by using the generated index.

A third database retrieval method according to the present invention comprises: making a comparison between a cost required when retrieval is performed after an index corresponding to a retrieval condition is generated and a cost required when entire retrieval is performed; determining whether or not two or more indexes which satisfy the retrieval condition by being combined exist among a plurality of already generated indexes, if the cost required when the entire retrieval is performed is higher as a result of the cost comparison; generating an index corresponding to the retrieval condition by combining the two or more indexes if the two or more indexes exist; and retrieving a database by using the generated index.

With the above described second and third database retrieval methods, a time required to generate a new index can be shortened by reusing already generated indexes. Namely, with the second retrieval method, a new index is generated by using an index which satisfies a condition wider than a retrieval condition if it exists. With the third database retrieval method, an index corresponding to a retrieval condition is generated by combining two or more existing indexes.

### BRIEF DESCRIPTION OF THE DRAWINGS

FIG. 1 shows blocks of the functions according to the present invention;

FIG. 2 is a block diagram showing the fundamental configuration of a database retrieval system according to the present invention;

FIG. 3 is a block diagram showing the configuration of an SQL processing system according to the present invention;

FIG. 4 exemplifies a database table;

FIG. 5 is a flowchart showing a reference access process for a database;

FIG. 6 is a flowchart showing an update/deletion access process for a database;

FIG. 7 exemplifies the generation of a dynamic index (No. 1);

FIG. 8 exemplifies the generation of a dynamic index (No. 2);

FIG. 9 exemplifies the generation of a dynamic index (No. 3);

FIG. 10 exemplifies the contents stored in a management dictionary corresponding to an index managing device;

FIG. 11 is a flowchart showing the process for determining the applicability of a dynamic index;

FIG. 12 exemplifies dynamic indexes;

FIG. 13 shows the ranges of the dynamic indexes shown in FIG. 12;

FIG. 14 is a flowchart showing the process for combining dynamic indexes;

FIG. 15 is a flowchart showing the process for managing the lifetime of a dynamic index; and

FIG. 16 explains the loading of a program for implementing the present invention into a computer.

FIG. 17 exemplifies the hardware configuration of an information processing device

### DESCRIPTION OF THE PREFERRED EMBODIMENTS

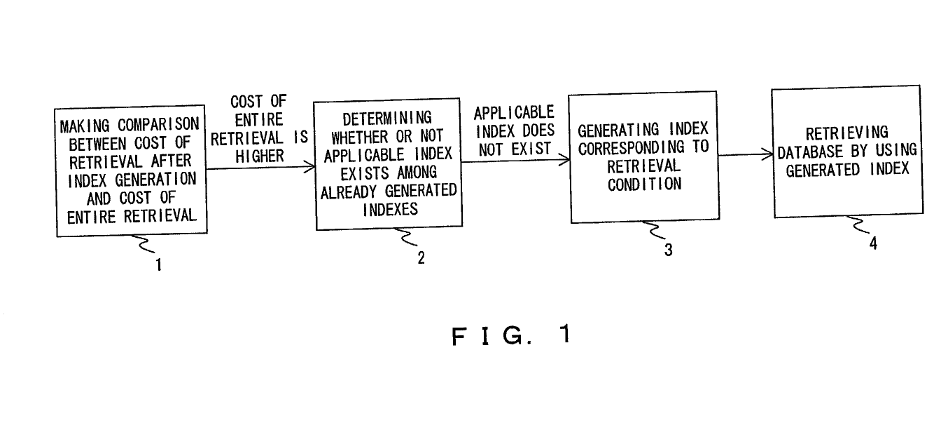

FIG. 1 shows blocks of the functions according to the present invention. This figure is a block diagram showing the functions of a program, which is stored onto a storage medium used by a computer retrieving a database, for example, a computer-readable portable storage medium such as a floppy disk, etc., and is intended to implement a database retrieving method according to the present invention.

With this program, a step of making a comparison between a cost required when retrieval is performed after an index corresponding to a retrieval condition is generated and a cost required when entire retrieval is performed is first executed in a block 1 of FIG. 1. Next, in a block 2, a step of determining whether or not an index that satisfies a retrieval condition and is applicable exists among already generated indexes is executed, if the cost required when the entire retrieval is performed is higher as a result of the cost comparison made in the block 1. In a block 3, a step of generating an index corresponding to the retrieval condition is executed if an applicable index is determined not to exist in the block 2. In a block 4, a step of retrieving a database by using the index generated in the block 3 is executed. These steps are executed by a computer.

According to the present invention, if the cost required when entire retrieval is performed is higher, the step in the block 3, that is, the generation of an index corresponding to a retrieval condition may be immediately made without determining whether or not an applicable index exists in the block 2 of FIG. 1, so that a database may be retrieved by using the generated index.

Additionally, available as a program stored onto a storage medium according to the present invention is a program for causing a computer to execute a process which comprises: making a comparison between a cost required when retrieval is performed after an index corresponding to a retrieval condition is generated and a cost required when entire retrieval is performed; determining whether or not an index which satisfies a condition wider than the retrieval condition exists among already generated indexes, if the cost required when the entire retrieval is performed is higher as a result of the cost comparison; generating an index which satisfies only the retrieval condition by using the index if the index which satisfies the wider condition exists; and retrieving a database by using the generated index.

Furthermore, available as the program stored onto the storage medium according to the present invention is a program for causing a computer to execute a process which comprises: making a comparison between a cost required when retrieval is performed after an index corresponding to a retrieval condition is generated and a cost required when entire retrieval is performed; determining whether or not two or more indexes which satisfy a retrieval condition by being combined exist among a plurality of already generated indexes, if the cost required when the entire retrieval is performed is higher as a result of the cost comparison; generating an index which satisfies the retrieval condition by combining the two or more indexes if the two or more indexes exist; and retrieving a database by using the generated index.

Still further, according to the present invention, the above described programs stored onto the storage medium may further comprise: managing data of the number of accesses, the generation date and time, and the update frequency of a generated index; and deleting the generated index according to its management status.

In a preferred embodiment of the present invention, the above described programs may further comprise: determining whether or not an already generated index that is applicable to an access process exists if an access to a database is a data update or deletion; determining whether or not the access performance of the access process is degraded due to the existence of such an index if the index exists; and deleting the index prior to the access process if the access performance is determined to be degraded.

As a database retrieving method retrieving a database according to the present invention, a database retrieving method using procedures similar to those of the above described programs stored onto the storage medium is used.

A database retrieving apparatus retrieving a database according to the present invention comprises: a cost comparing unit making a comparison between a cost required when retrieval is performed after an index corresponding to a retrieval condition is generated and a cost required when entire retrieval is performed; an applicable index determining unit determining whether or not an index which satisfies the retrieval condition and is applicable exists among already generated indexes, if the cost required when the entire retrieval is performed is higher as a result of the cost comparison; an index generating unit generating an index corresponding to the retrieval condition if an applicable index does not exist; and a retrieving unit retrieving a database by using the generated index.

This database retrieving apparatus may further comprise an index managing unit managing the data generation condition of a generated index, and an index storage area.

As described above, according to the present invention, it becomes possible to dynamically generate a required index or to reuse an already generated index, especially when irregular database retrieval is performed.

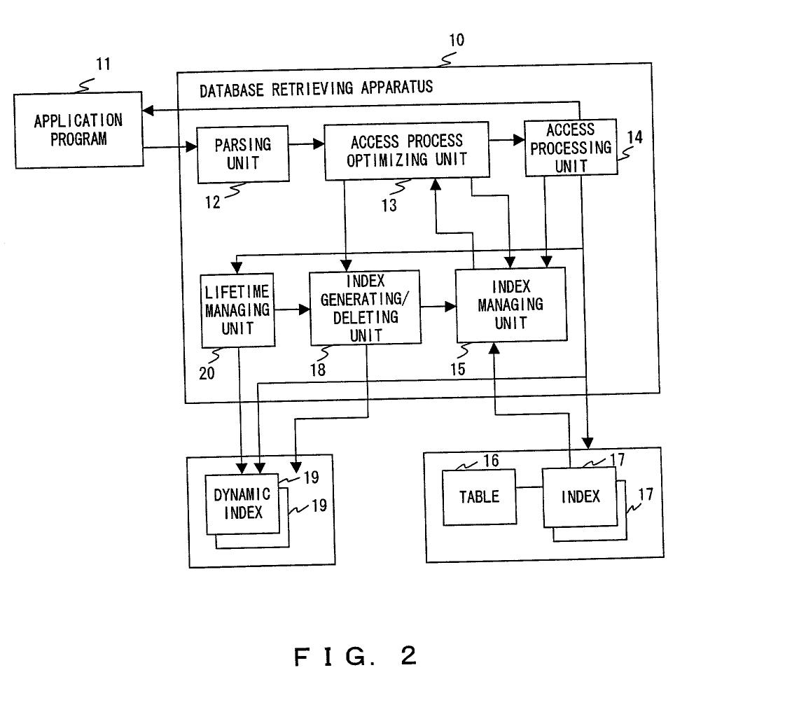

FIG. 2 is a block diagram showing the fundamental configuration of a database retrieving system to which the database retrieval method according to the present invention is applied. In this figure, a constituent element playing a leading role in this system is a database retrieving apparatus 10.

The database retrieving apparatus 10 comprises: a parsing unit 12 parsing an SQL statement and a database retrieval condition if the SQL statement as a database retrieval request is provided from an application program 11; an access process optimizing unit 13 determining an access method the speed of which becomes the fastest according to a result of the parsing made by the parsing unit 12; an access processing unit 14 making an access to a database by using the access method determined by the access process optimizing unit 13; an index managing unit 15 managing an index for a database; an index generating/deleting unit 18 generating a dynamic index 19 if an index applicable to an access to the database does not exist among a plurality of indexes 17 for a table 16 which actually stores data within the database, or deleting a generated dynamic index depending on need; and a lifetime managing unit 20 managing the lifetime of a dynamic index.

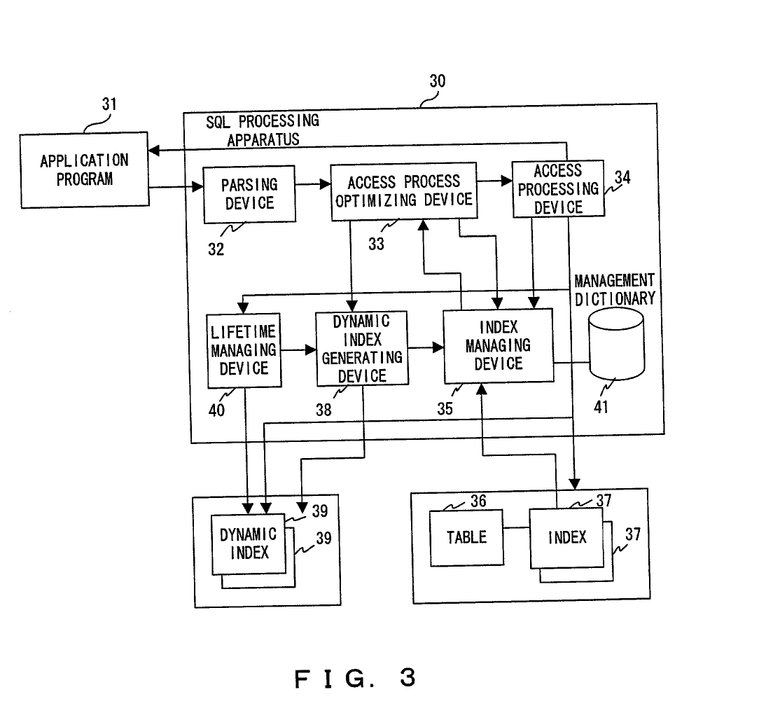

FIG. 3 is a block diagram showing the configuration of an SQL processing system according to a preferred embodiment of the present invention. The configuration shown in this figure is analogous to that of the database retrieving system shown in FIG. 2. However, there is a fundamental difference in a point that a management dictionary 41 is arranged within an SQL processing apparatus 30 that corresponds to the database retrieving apparatus 10. The same constituent elements as those in the configuration of the database retrieving apparatus 10 are not explained here.

Operations of the SQL processing apparatus 30 shown in FIG. 3 are further explained. As described above, a parsing device 32 (that is, same as the parsing unit 12) parses an SQL statement and a retrieval condition, an access process optimizing device 33 determines, according to a result of the parsing, whether a process becomes faster, for example, either by making an access to a database after newly generating a dynamic index, or by performing entire retrieval for the database without generating a dynamic index, and an access processing device 34 makes an access to the database according to a result of the determination.

At this time, if it is determined that the process becomes faster by generating a dynamic index, a dynamic index generating device 38 generates a dynamic index 39, and the access processing device 34 makes an access to a table 36 of the database by using the generated dynamic index.

Furthermore, the access process optimizing device 33 inquires of an index managing device 35 as to whether or not an already generated index 37 or a dynamic index 39 can be used, when determining an access method. If a suitable index that can be used for an access exists, an index managing device 35 that manages the indexes 37 and the dynamic indexes 39 notifies the access process optimizing device 33 of its existence. As a result, the access processing device 34 can make an access to the table 36 of the database by using the notified generated index 37 or dynamic index 39.

If the access process optimizing device 33 determines that the access performance is degraded due to a dynamic index update that must be made along with a data update if an access to the database is, for example, the data update, the dynamic index generating device 38 deletes the dynamic index 39.

Additionally, if an access can be made to the database by using part of the indexes 37 or the dynamic indexes 39, which are managed by the index managing device 35, or by combining these indexes, the access processing device 34 can make an access to the database by using a dynamic index 39 which is generated with part of an index or an index combination.

Furthermore, if an access can be made by generating an index with an addition of a new condition to the indexes 37 or the dynamic indexes 39, such an index is generated, and the access processing device 34 makes an access.

Information (such as a generation condition, a size, column information, etc.) of the dynamic index generated by the dynamic index generating device 38 are transmitted to the index managing device 35. The index managing device 35 stores these information of the dynamic indexes and those of the normal indexes 37 in the management dictionary 41, and manages the information. Contents of the management dictionary 41 will be described later.

A lifetime managing device 40 is intended to manage the lifetime, that is, the valid term of a dynamic index that the dynamic index generating device 38 generates, for example, in a working area of a memory. The lifetime is managed according to a time elapsed from the generation of an index, the number of accesses, an update frequency, etc.

For instance, a request to delete a dynamic index is issued to the dynamic index generating device 38 in descending order of the update frequency, so that the dynamic index is deleted. If a large amount of data is updated by an access to the database, also dynamic indexes must be updated. Therefore, the dynamic indexes are deleted in advance.

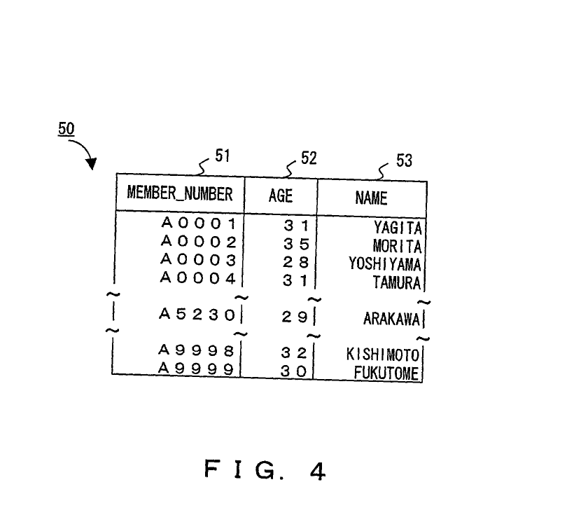

FIG. 4 shows an example of a table 36 configuring a database. This example illustrates a member table 50, which is composed of three entries (columns) such as a member number 51, an age 52, and a name 53. It is assumed that each row stores one piece of data (one record), and 99 pieces of data (99 records) are stored in total.

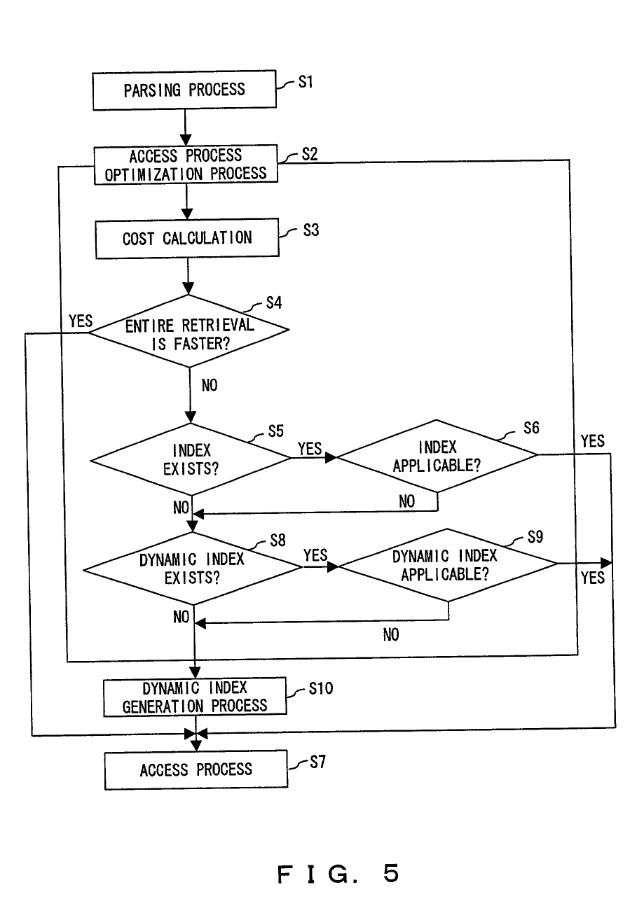

FIG. 5 is a flowchart showing a database access process if an access to a database is a data reference. Once the process is started in this figure, a parsing process is first performed in step S1. In this process, when an SQL statement is input from the application program 31 to the SQL processing apparatus 30 shown in FIG. 3, the input SQL statement is parsed. That is, information such as the type of the SQL statement, a table to be accessed, a retrieval condition, etc. are parsed, and the parsed information are stored as the information for an access process optimization process in the next step S2.

As described above, the access process optimization process in step S2 is intended to decide an access method having the fastest speed of an access to the database as described above, and is composed of the processes in steps S3 through S9.

In the access process optimization process, for example, if there are a plurality of tables, which must be joined, an access order to the tables, an access procedure, that is, entire scanning, an access using an index, etc. are decided. The access procedure is decided according to the total number of pieces of data, a data distribution, a retrieval condition, etc., so that an access speed becomes the fastest.

The case where the following SQL statement is input for the table 50 shown in FIG. 4 is considered. SELECT*FROM MEMBER_TABLE WHERE MEMBER_NUMBER BETWEEN ‘A4500’ AND ‘A6500’ ORDER BY MEMBER_NUMBER

A column targeted as a retrieval condition is the member number column as a result of the parsing process in step S1, and the condition is that the member numbers are between A4500 and A6500. In addition, sorting must be made in ascending order of the member numbers.

Next, a cost required when an access is made after a dynamic index corresponding to a retrieval condition is generated for the member numbers as the column, a cost required when an access is made by using an already existing index or dynamic index, and a cost required when entire scanning is performed for the 9999 pieces of data are calculated as a cost calculation process in step S3, which is an internal step of the access process optimization process, that is, step S2. In step S4, it is determined whether or not the entire scanning is faster.

If it is determined that, for example, an access made after a dynamic index is generated is faster than the entire scanning in step S4, it is further determined whether or not indexes already exist, namely, whether or not the indexes 37 shown in FIG. 3 exist in step S5. If the indexes exist, it is determined whether or not any of the indexes is applicable in step S6. If any of the indexes is applicable, the access process is performed by using the index in step S7.

If it is determined that no indexes exist in step S5 or existing indexes are not applicable although they exist in step S6, it is further determined whether or not dynamic indexes already exist, that is, whether or not the dynamic indexes 39 shown in FIG. 3 have been generated in step S8. If the dynamic indexes already exist, it is determined whether or not any of the dynamic indexes is applicable in step S9. If any of the dynamic indexes is applicable, the access process is performed in step S7.

If it is determined that no dynamic indexes exist in step S8, or if it is determined that the dynamic indexes are not applicable although they exist in step S9, a dynamic index is generated in step S10. Then, the access process is performed by using the generated dynamic index in step S7. If it is determined that the entire scanning is faster than the access made after a dynamic index is generated in step S4, the access process is immediately performed with the entire scanning in step S7.

Note that the access process is considered to become faster by using already generated index or dynamic indexes, even if, for instance, the access made after a dynamic index is newly generated is determined to be faster than the entire scanning in step S4. The processes in steps S5 through S9 are therefore performed. If any of already generated indexes or dynamic indexes is applicable, the access process is performed by using the index.

Here, the speed of an access made by using an index, and that of an access made with entire scanning without using an index are explained. For simplicity of explanation, the case where there is only one record (one piece of data) is considered. If the data is read by using an index, the index is first read. Next, for example, an address value is searched, and a file is read in correspondence with the address value. Therefore, two inputs/outputs are required. If an index is not used, only a file read is performed. Namely, one input/output is required. Accordingly, an access made by using an index becomes slower at a read of one piece of data.

Whether or not an access using an index becomes faster depends on the number of pieces of data to be read from among the total pieces of data. By way of example, if only one piece of data satisfying a condition is read from among one hundred thousand pieces of data, an access using an index becomes faster as a matter of course. In the meantime, if ninety thousand pieces of data satisfying a condition are read from among one hundred thousand pieces of data, entire scanning becomes faster.

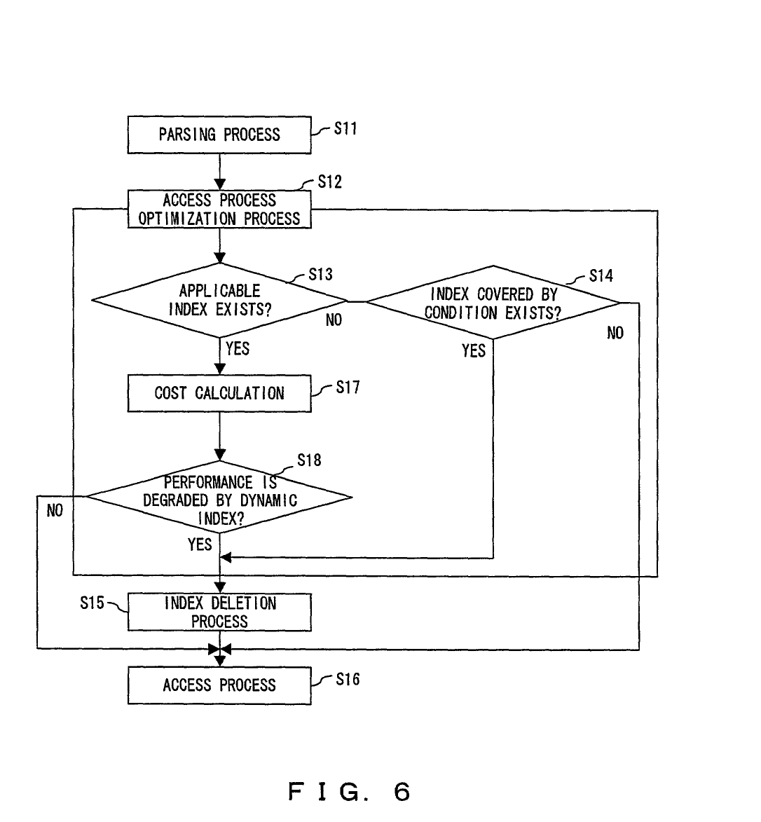

Namely, it is inappropriate to always perform a simple process such as making an index access even if indexes exist. Which access procedure becomes the optimum must be determined by making the cost calculation. Especially, if there are a plurality of conditions, the comparison between the case where an access is made by using an index for each of the conditions, and the case where an access is made with entire scanning must be made beforehand. FIG. 6 is a flowchart showing the access process if an access to a database is a data update or deletion. Once the process is started in this figure, a parsing process is first performed in step S11 in a similar manner as in step S1 of FIG. 5. In this process, information such as the type of an SQL statement input from the application program, a table to be accessed, a retrieval condition, etc., are parsed as described above, and the parsed information are stored in the table within the SQL processing apparatus 30.

Here, assume that a dynamic index already exists for the condition that the member numbers are between A4500 and A6500, which corresponds to the above described SQL statement, as the dynamic index generated in step S10 of FIG. 5. The case where the following SQL statement is input to delete data within the database is considered based on this assumption.

DELETE FROM MEMBER_TABLE WHERE MEMBER_NUMBER>‘A0500”

In response to the input of this SQL statement, in an access process optimization process in step S12 of FIG. 6, it is first determined whether or not an applicable index exists in step S13. Here, since no index corresponding to a member number which is equal to or lager than A0500 exists, it is determined whether or not an index covered by the retrieval condition exists in step S14.

Because the dynamic index for the member numbers between A4500 and A6500 is covered by the retrieval condition, data corresponding to this index is deleted, and the dynamic index itself become invalid. An access process, that is, a data deletion process for the database is actually performed in step S16 after an index deletion process is performed in step S15.

In contrast, the case where the above described dynamic index exists, and the following SQL statement is input is considered.

DELETE FROM MEMBER_TABLE WHERE MEMBER_NUMBER≧‘A5000’ AND MEMBER_NUMBER≦‘A5010’

In this deletion process, data corresponding to member numbers between A5000 and A5010 is deleted. However, it is determined that an applicable index exists in step S13, and a cost calculation is made in step S17. In this case, the number of pieces of data to be deleted is small, and a time required to delete a portion corresponding to the dynamic index is not long. Accordingly, it is determined that access performance is not degraded as a result of determining whether or not the performance is degraded due to the existence of the dynamic index in step S18. The access process in step S16 is therefore performed without deleting the dynamic index.

Or, if the number of pieces of data to be deleted is large among the data of the member numbers corresponding to the dynamic index, and so it is determined that the access performance is degraded due to the existence of the dynamic index, the access process is performed in step S16 after the deletion process for the dynamic index is performed in step S15. Additionally, if it is determined that no index covered by the condition exists in step S14, the access process is immediately performed in step S16. As described above, in this preferred embodiment, performance degradation due to the existence of a dynamic index can be prevented even when data (a record) is deleted or updated.

Here, the cost required for deleting data within a database is explained. In a similar manner as in the case of a data reference, when only one record (one piece of data) is deleted, an index is first referenced if it is used, and the data is actually deleted, for example, by determining an address value. If an index is not used, actual data may be deleted by determining an address value. Therefore, a deletion using an index becomes slower, because a reference is made to the index.

Note that, however, this is the case where only one record is deleted. If one piece of data is deleted, for example, from among one hundred thousand pieces of data, a process using an index becomes faster than a process using entire retrieval. Whether or not a process using an index is faster depends on the characteristic of a database. Therefore, it is difficult to simply determine what percentage or more of data is deleted to make a process using entire retrieval faster, and its determination method varies, by way of example, as follows. An index is not used, for instance, if 50 percent of entire data becomes a deletion target, or the like.

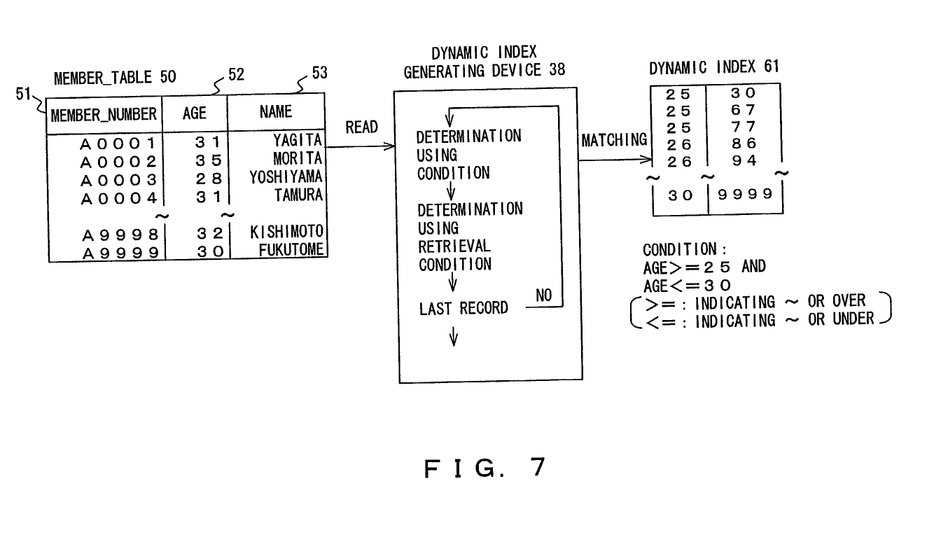

FIGS. 7 through 9 explain the generation of a dynamic index. FIG. 7 exemplifies the process performed when an index is not generated for a column for which a dynamic index is to be generated. Here, assume that a dynamic index is generated in response to the following SQL statement.

SELECT*FROM MEMBER_TABLE WHERE AGE≧25 AND AGE≦30

The dynamic index generating device 38 shown in FIG. 3 performs entire scanning for the data of the target table, repeats a determination using a condition and a determination using a retrieval condition, normally, up to the last record, and generates a dynamic index by selecting data which satisfy these conditions. Here, a combination of the condition and the retrieval condition corresponds to a retrieval condition for a database.

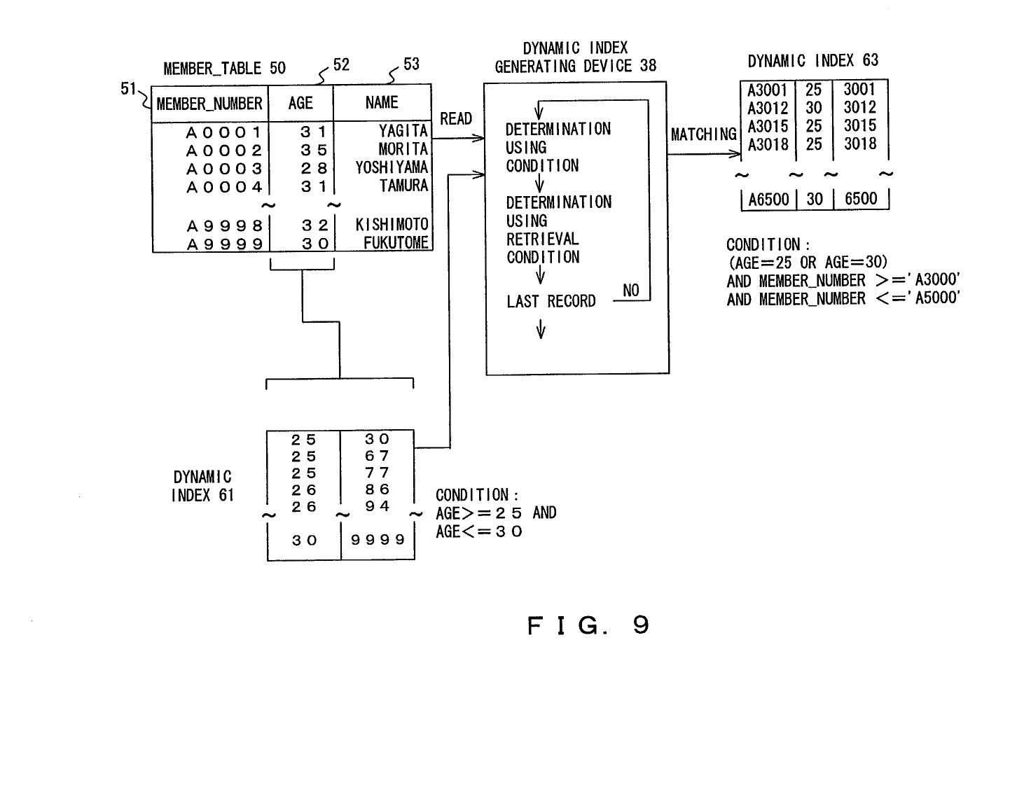

In FIG. 7, not a determination using a retrieval condition but only a determination using a condition is made for the data of the ages between 25 and 30. By way of example, as explained with reference to FIG. 9, a member number determination that is further made for data satisfying an age condition, which is resultant from the determination using a condition, corresponds to a determination using a retrieval condition. In a dynamic index 61 generated in FIG. 7, for instance, the first row “30” corresponds to a member number A0030, and indicates the physical address of this record within the member table.

A dynamic index is generated, for example, in a working area of a memory. Information such as the generation condition, a relation with a table, etc. of a generated dynamic index are transmitted to the index managing device 35 shown in FIG. 3. The working area in which an index is generated may be on a disk.

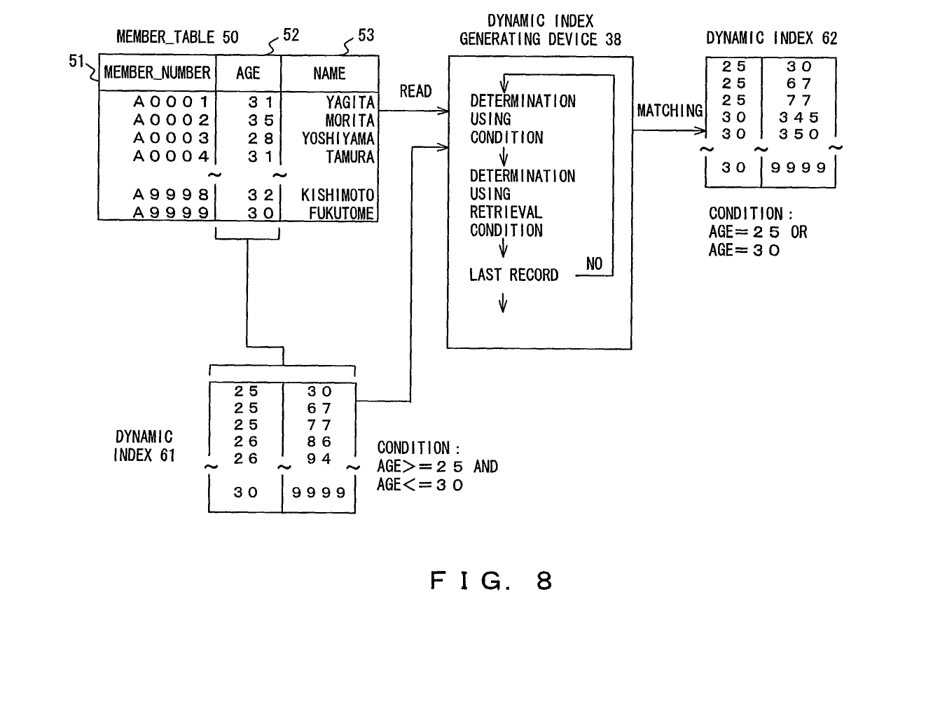

FIG. 8 exemplifies the process performed when an index or a dynamic index has already been generated for a column for which a dynamic index is to be generated. This is an example where the following SQL statement is input to the table shown in FIG. 4.

SELECT*FROM MEMBER_TABLE WHERE AGE=25 OR AGE=30

In FIG. 8, only data of ages 25 and 30 is selected as a condition by using as a condition the dynamic index 61 that has already been generated in FIG. 7, namely, the dynamic index 61 corresponding to the ages between 25 and 30, so that a final dynamic index 62 is generated. This index generation can be made faster than the generation of a final dynamic index 62, which is made by performing entire scanning for the table 50 as a target from scratch.

As described above, in this preferred embodiment, retrieval can be made faster and resources can be saved with the use of a dynamic index that is generated by adding a new condition to an already generated dynamic index.

FIG. 9 exemplifies the generation of a final dynamic index 63 by adding a new condition as a retrieval condition to the already generated dynamic index 61. Namely, a determination using a condition of an age 25 or 30 is made for the dynamic index 61 generated in FIG. 7, and a determination using a retrieval condition of member numbers between A3000 and A5000 is further made, so that the final dynamic index 63 is generated. This dynamic index 63 is generated in response to the input of the following SQL statement.

SELECT*FROM MEMBER_TABLE WHERE (AGE=25 OR AGE=30) AND MEMBER_NUMBER≧‘A3000’ AND MEMBER_NUMBER≦‘A5000’

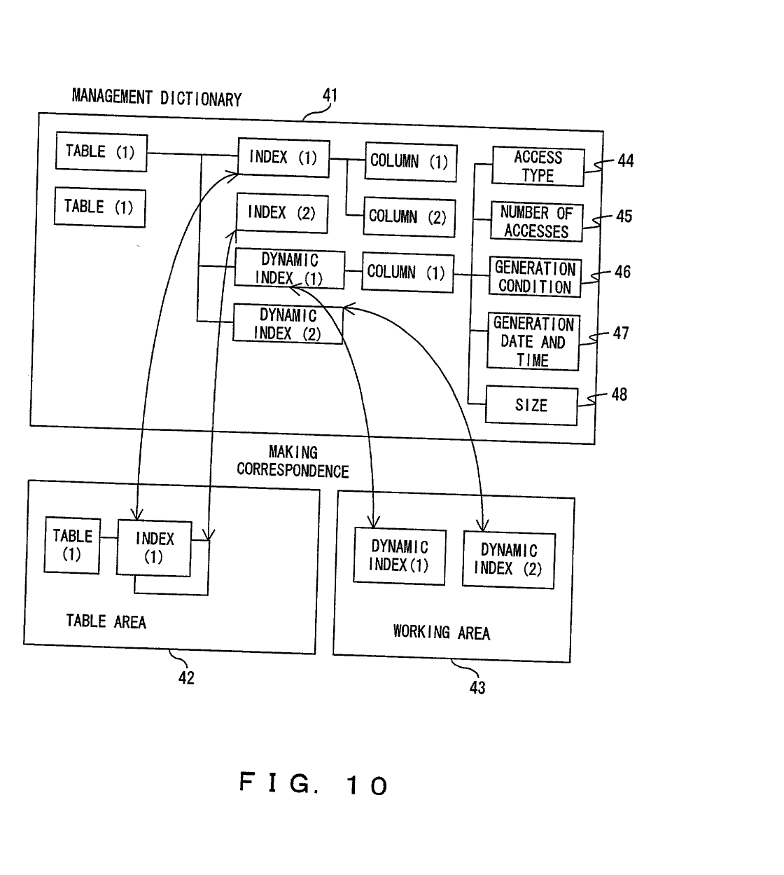

FIG. 10 shows the contents of the management dictionary 41 shown in FIG. 3. The management dictionary 41 stores the names of indexes (such as an index (1), an index (2), a dynamic index (1), . . . ), the name of a table in which the indexes are generated (such as a table (1)), the names of columns to which the generation conditions of the index (1), namely, the above described conditions and retrieval conditions are applied (such as a column (1), a column (2), etc.), and the like. For a dynamic index, further more, information such as the number of accesses 45 and an access type 44 (reference, update, or deletion) are stored in addition to the generation date and time 47, the generation condition 46 (corresponding to a retrieval condition), and the size 48 of a dynamic index in correspondence with the name of a column so as to manage the lifetime.

The names of indexes and dynamic indexes stored within the management dictionary 41 are respectively corresponded to the indexes themselves within the table area 42 and the dynamic indexes themselves within the working area 43.

The size 48 of a dynamic index stored within the management dictionary 41 is intended to manage the working area in which the dynamic index is stored, as will be described later. The generation date and time 47 indicates the time point at which a dynamic index is generated, and the number of accesses 45 is updated each time a corresponding index is used.

Data registration/deletion is made to/from the management dictionary 41 by using a DDL (Data Definition Language) statement that manipulates an index, such as a CREATE INDEX statement, a DROP INDEX statement, a uniqueness constraint definition/deletion statement, etc. Additionally, information registration/deletion is made to/from the management dictionary 41 in correspondence with the generation of a dynamic index, which is made by the dynamic index generating device 38, or the deletion of a dynamic index, which is instructed by the lifetime managing device 40.

In FIG. 3, the index managing device 35 manages, for example, the area in which a dynamic index is generated by using the contents of the management dictionary 41. However, the dynamic index generating device 38 may make this area management.

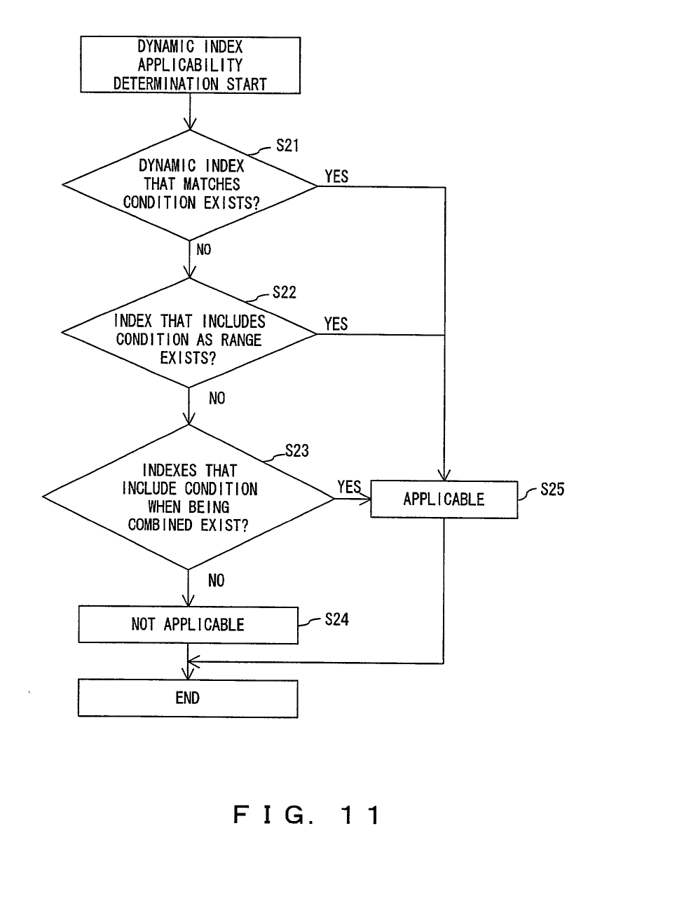

FIG. 11 is a flowchart showing the process for determining the applicability of a dynamic index. Once the process is started in this figure, it is first determined whether or not a dynamic index that matches a retrieval condition for a database exists in step S21. If it is determined that such an index does not exist in step S21, it is further determined whether or not an index that includes the retrieval condition as its range, namely, an index that matches a condition wider than the retrieval condition exists in step S22. If it is determined that such an index does not exist in step S22, it is then determined whether or not a plurality of already existing indexes that include the retrieval condition by being combined exist in step S23. If such indexes do not exist, it is determined that a dynamic index is not applicable in step S24. Here, the process is terminated.

If it is determined that a dynamic index which perfectly matches the retrieval condition exists in step S21, if it is determined that an index which matches a condition wider than the retrieval condition exists in step S22, or if it is determined that a plurality of indexes which include the retrieval condition by being combined exist in step S23, a dynamic index is determined to be applicable in step S25. Here, the process is terminated. Combinations of a plurality of indexes in step S23 will be described later.

Normally, a dynamic index is used for irregular retrieval. In this sense, there is a strong possibility that a dynamic index can be used only under the retrieval condition when being generated. For this reason, reuse of a dynamic index is normally difficult. However, according to this preferred embodiment, the generation condition of a dynamic index is stored, which eliminates the need for generating a new dynamic index by performing retrieval, for example, with a combination of dynamic indexes, if retrieval corresponding to a new retrieval condition can be enabled by using part of a dynamic index or a combination of a plurality of dynamic indexes. As a result, the working area for generating a dynamic index can be reduced in size, and the process for newly generating a dynamic index becomes unnecessary, thereby performing retrieval at high speed.

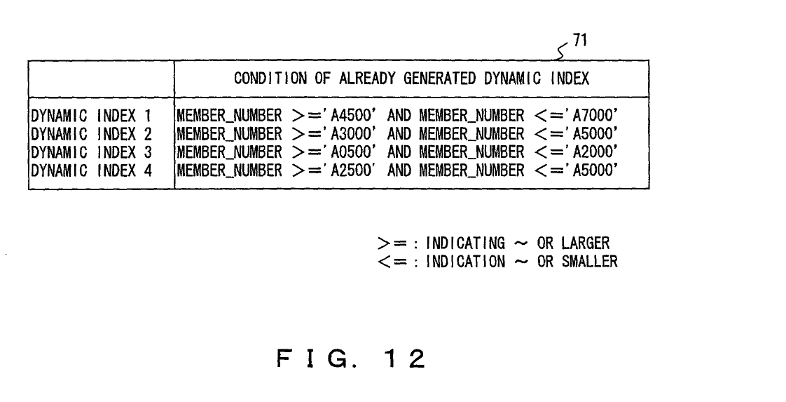

FIGS. 12 through 14 explain combinations of dynamic indexes. FIG. 12 shows already generated dynamic indexes 1 through 4, which are respectively conditioned with member numbers (condition 71).

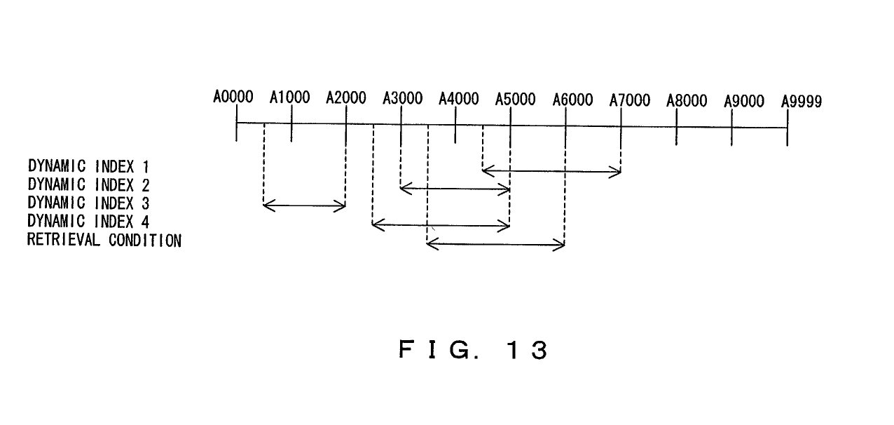

FIG. 13 shows the ranges of the member numbers of the dynamic indexes 1 through 4 shown in FIG. 12, and the range of a retrieval condition corresponding to a new SQL statement. Here, the new SQL statement is the following one.

SELECT*FROM MEMBER_TABLE WHERE MEMBER_NUMBER≧‘A3500’ AND MEMBER_NUMBER≦‘A6000’

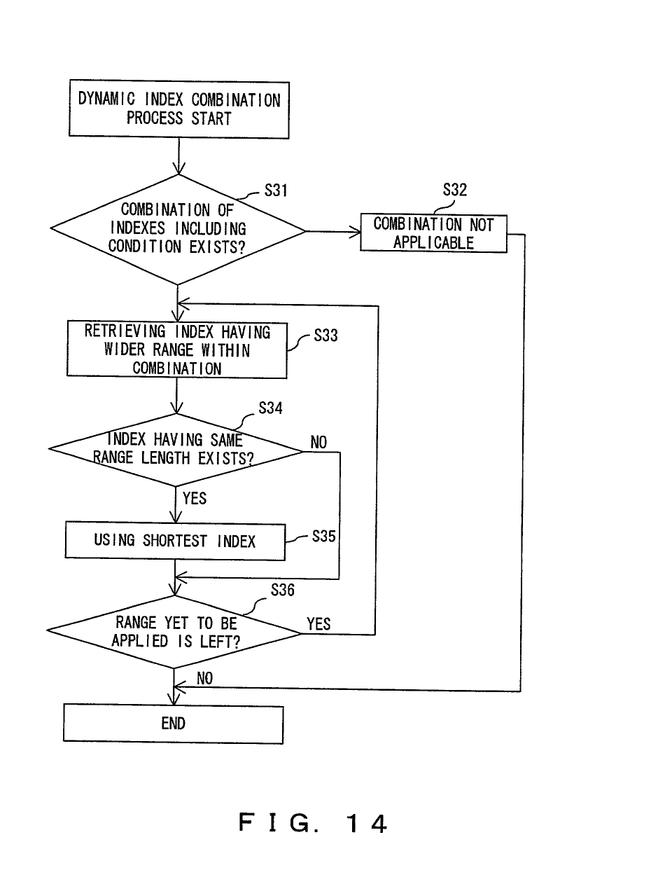

FIG. 14 is a flowchart showing the process for combining dynamic indexes. Once the process is started in this figure, it is determined whether or not a combination of indexes, which includes a retrieval condition, exists in step S31. If such a combination does not exist, it is determined that a combination is not applicable in step S32. Then, the process is terminated.

Or, if it is determined that a combination of the dynamic indexes 1 and 2 or a combination of the dynamic indexes 1 and 4 exists as the combination of indexes, which includes the retrieval condition corresponding to the above provided SQL statement, namely, the retrieval condition of the member numbers between A3500 and A6000, an index that includes the retrieval condition as the widest range is retrieved from among the indexes structuring these combinations in step S33. This is because using an index having the widest range reduces the number of times that switching is made to apply an index, and the process can be made faster.

Here, the dynamic index 1, the dynamic index 2, and the dynamic index 4 respectively include the ranges having the same length, that is, the ranges between A4500 and A6000, between A3500 and A5000, and between A3500 and A5000 as the member numbers in the retrieval condition. Therefore, it is assumed that the 3 dynamic indexes 1, 2, and 4 have been retrieved.

Next, in step S34, it is determined whether or not an index including the same range length exists among the retrieved indexes. Here, all of the dynamic indexes 1, 2, and 4 are determined to include the same range length. Then, in step S35, the shortest index is used. This is because an access can be made faster to an index the whole length of which is shorter among indexes including the same range length.

Here, the dynamic index 2 is determined to be used as an index the whole length of which is the shortest. In step S36, it is determined whether or not a range yet to be applied is left in the retrieval condition.

Since only the dynamic index 2 is selected here, the range between the member numbers A5000 and A6000 in the retrieval condition is not applied. The process therefore goes back to step S33 where the dynamic index 1 is retrieved as an index including this range of the condition. It is then determined that no index including the same range length exists in step S34, and it is also determined that no range yet to be applied exists in step S36. Here, the process is terminated.

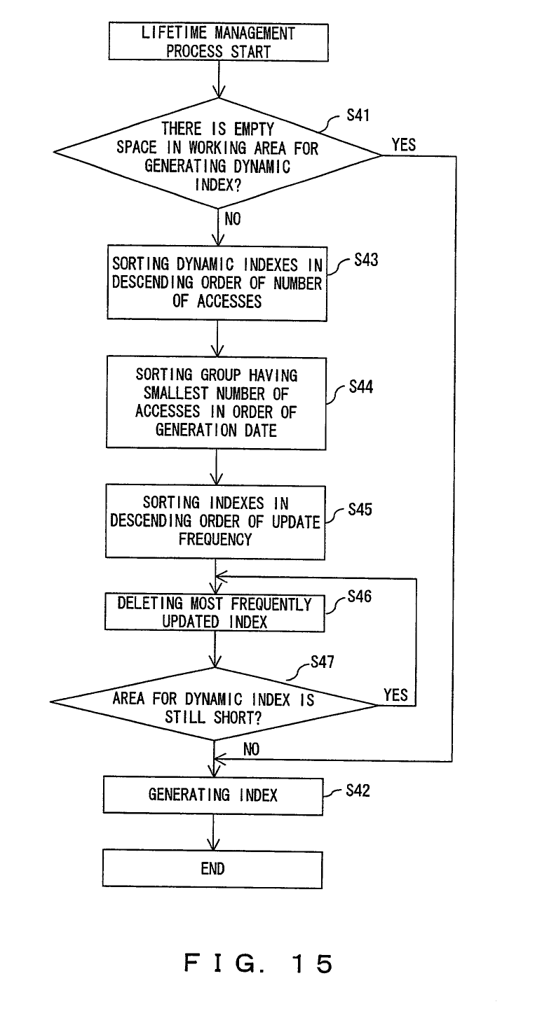

FIG. 15 is a flowchart showing the process for managing the lifetime of a dynamic index. In this preferred embodiment, management of the lifetime of a dynamic index is explained by assuming that whether or not there is an empty space in the working area for generating a dynamic index is determined to generate a new dynamic index, and an already generated dynamic index is deleted if there is no empty space. Naturally, however, such lifetime management can be made, for example, depending on need regardless of whether or not there is an empty space in the working area for generating a dynamic index.

Once the process is started in FIG. 15, it is determined whether or not there is an empty space in the working area for generating a dynamic index in step S41. If there is an empty space, a new dynamic index is generated in step S42, and the process is terminated.

If there is no empty space in the working area, already generated dynamic indexes are sorted in descending order of the number of accesses in step S43. Then, a dynamic index group having the smallest number of accesses is sorted in order of the generation date and time, and the dynamic indexes having the oldest generation date and time are extracted in step S44.

In step S45, the extracted dynamic indexes are further sorted in descending order of an update frequency, namely, the ratio of the number of updates to the number of accesses. In step S46, an index having the highest update frequency is deleted. In this way, a deletion starts from the dynamic index having the smallest number of accesses, the oldest generation date and time, and the highest update frequency.

In step S47, it is determined whether or not the working are for generating a dynamic index is still short. If the working area is still short, the process goes back to step S46. Then, the process for deleting an index having the second highest update frequency, and the subsequent processes are repeated. If it is determined that the working area for generating a dynamic index is freed up in step S47, a new dynamic index is generated in step S42. Here, the process is terminated.

Normally, a dynamic index generated in correspondence with a certain retrieval condition is stored within a system in the expectation of the possibility of its reuse. However, if the working area for generating a dynamic index becomes short, an index having a lower priority is deleted from among already generated indexes. As a result, an index to which a reference access is frequently made becomes reusable, and a frequently updated dynamic index becomes easy to be deleted, thereby efficiently reusing a dynamic index.

In FIG. 15, dynamic indexes are prioritized for deletion in the order of the number of accesses, the generation date and time, and the update frequency. However, this order may be set arbitrarily depending on a system.

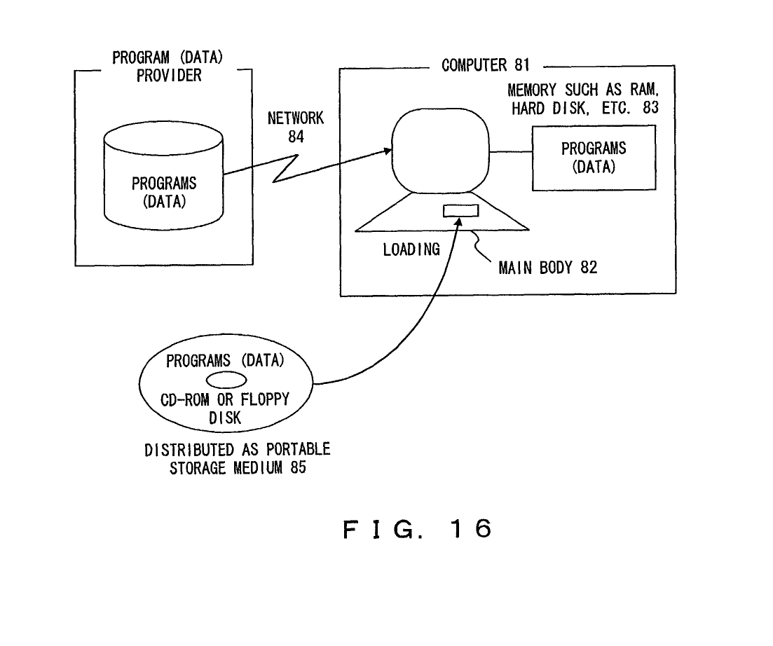

The above described database retrieving method can be implemented by a general computer system, as a mater of course. FIG. 16 is a block diagram showing the configuration of such a computer system. In this figure, a computer 81 for implementing the database retrieving method (system) according to the present invention is configured by a main body 82 and a memory 83. The memory 83 is a storage device such as a random access memory (RAM), a hard disk, a magnetic disk, etc. Programs recited in claims 1 through 5 of the present invention, or the programs represented by the flowcharts shown in FIGS. 5, 6, 11, 14, and 15 are stored in such a memory. The programs are executed by the main body 82, thereby implementing the database retrieving method according to the present invention.

Such programs may be loaded from a program provider side to the computer 81 via a network 84. Or, the programs maybe stored onto a portable storage medium 85 that is marketed and distributed, and the portable storage medium 85 is inserted into the computer 81, so that the programs may be executed by the main body 82.

As the portable storage medium 85, a variety of storage media such as a CD-ROM, a floppy disk, an optical disk, a magneto-optical disk, etc. are available. The above described programs are stored onto such storage media, whereby the database retrieving method according to the present invention can be implemented.

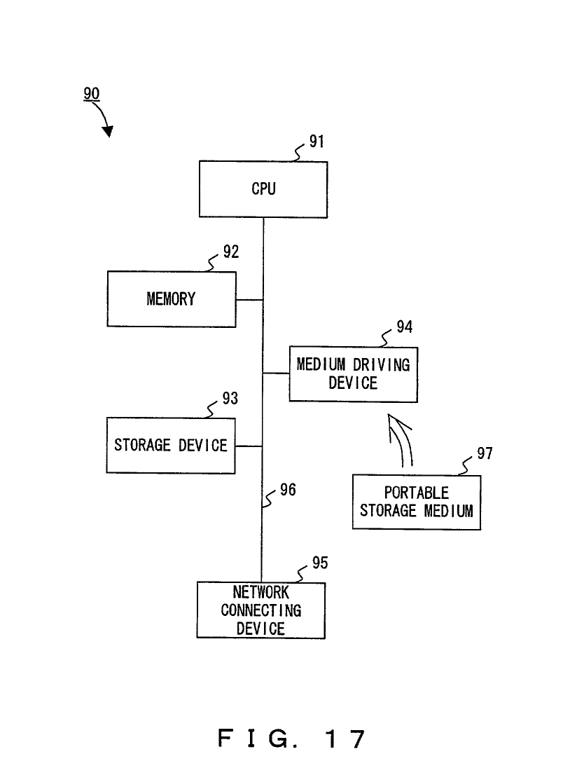

FIG. 17 exemplifies the hardware configuration of an information processing device implementing the above described processes of various types.

An information processing device 90 shown in this figure comprises a CPU 91, a memory 92, a storage device 93, a medium driving device 94, and a network connecting device 95, which are interconnected by a bus 96. The configuration shown in this figure is merely one example, and the hardware configuration is not limited to this one.

The CPU 91 is a central processing device that controls the whole the information processing device 90.

The memory 92 is a memory such as a RAM, etc., which temporarily stores the programs or data stored in the storage device 95 (or a portable storage medium 97), when the programs are executed, the data is updated, etc. The CPU 91 executes the above described processes of various types by using the programs/data loaded into the memory 92.

The storage device 93 is, for example, a magnetic disk device, an optical disk device, a magneto-optical disk device, etc., and stores the programs/data for implementing a variety of processes/capabilities as the above described database retrieving apparatus.

Or, these programs/data may be stored onto the portable storage medium 97. In this case, the programs/data stored onto the portable storage medium 97 are read by the medium driving device 94. The portable storage medium 97 is, for example, an FD (Floppy Disk), a CD-ROM, a DVD, a magneto-optical disk, etc.

Or, the above described programs/data may be stored in an external device, and downloaded via a network connected by the network connecting device 95. The present invention may be configured as a storage medium (portable storage medium 97, etc.) it self storing the above described programs/data, as a network (transmission medium) itself transmitting the above described programs/data, or as a transmission signal itself transmitted via the transmission medium at the time of downloading.

As described above in detail, according to the present invention, retrieval can be made by dynamically generating an index required for the retrieval if an index required for retrieving a database does not exist, or if an index cannot be used for retrieval unchanged although it exists. This greatly contributes to an improvement in the retrieval performance of a database.

Generally, an index generated for a particular condition is only applicable to a retrieval condition that matches the condition. According to the present invention, however, it becomes possible to apply an index to part of a particular condition, or to apply a plurality of indexes by being combined, thereby reducing the working are for generating an index, a time required to generate an index, and a time required for a database retrieval process. Furthermore, the lifetime of a dynamic index is managed, whereby the dynamic index can be effectively reused. Still further, a dynamic index is deleted when a large amount of data is updated, thereby preventing access performance from being degraded.

What is claimed is:

1. A database retrieving method, comprising:
making a comparison between a cost required when retrieval is performed after an index corresponding to a retrieval condition is generated and a cost required when entire retrieval is performed;
generating an index corresponding to the retrieval condition if the cost required when the entire retrieval is performed is higher as a result of the cost comparison; and
retrieving a database by using the generated index.

2. A database retrieving method, comprising:
making a comparison between a cost required when retrieval is performed after an index corresponding to a retrieval condition is generated and a cost required when entire retrieval is performed;
determining whether or not a first index which satisfies a condition wider than the retrieval condition exists among already generated indexes, if the cost required when the entire retrieval is performed is higher as a result of the cost comparison;
generating a second index which satisfies only the retrieval condition by using the first index, if the first index which satisfies the wider condition exists; and
retrieving a database by using the generated second index.

3. A database retrieving method, comprising:
making a comparison between a cost required when retrieval is performed after an index corresponding to a retrieval condition is generated and a cost required when entire retrieval is performed;
determining whether or not two or more indexes which satisfy the retrieval condition by being combined exist among a plurality of already generated indexes, if the cost required when the entire retrieval is performed is higher as a result of the cost comparison;
generating an index corresponding to the retrieval condition by combining the two or more indexes, if the two or more indexes exist; and
retrieving a database by using the generated index.

4. The database retrieving method according to claim 1, further comprising:
managing data of the number of accesses, a generation date and time, and an update frequency of the generated index; and
deleting the generated index according to management status of the data.

5. The database retrieving method according to claim 1, further comprising:
determining whether or not an already generated index that is applicable to an access process exists, if an access to the database is a data update or deletion;
determining whether or not access performance of the access process is degraded due to existence of the index, if the index exists; and
deleting the index prior to start of the access process, if the access performance is degraded.

6. The database retrieving method according to claim 2, further comprising:
managing data of the number of accesses, a generation date and time, and an update frequency of the generated index; and
deleting the generated index according to management status of the data.

7. The database retrieving method according to claim 2, further comprising:
determining whether or not an already generated index that is applicable to an access process exists, if an access to the database is a date update or deletion;
determining whether or not access performance of the access process is degraded due to existence of the index, if the index exists; and
deleting the index prior to start of the access process, if the access performance is degraded.

8. The database retrieving method according to claim 3, further comprising:
managing data of the number of accesses, a generation date and time, and an update frequency of the generated index; and
deleting the generated index according to management status of the data.

9. The database retrieving method according to claim 3, further comprising:
determining whether or not an already generated index that is applicable to an access process exists, if an access to the database is a data update or deletion;
determining whether or not access performance of the access process is degraded due to existence of the index, if the index exists; and
deleting the index prior to start of the access process, if the access performance is degraded.

10. A computer-readable storage medium on which is recorded a program for causing a computer to execute a process when being used by the computer, said process comprising:
making a comparison between a cost required when retrieval is performed after an index corresponding to a retrieval condition is generated and a cost required when entire retrieval is performed;
generating an index corresponding to the retrieval condition if the cost required when the entire retrieval is performed is higher as a result of the cost comparison; and
retrieving a database by using the generated index.

11. A computer-readable storage medium on which is recorded a program for causing a computer to execute a process when being used by the computer, said process comprising:
making a comparison between a cost required when retrieval is performed after an index corresponding to a retrieval condition is generated and a cost required when entire retrieval is performed;
determining whether or not a first index which satisfies a condition wider than the retrieval condition exists among already generated indexes, if the cost required when the entire retrieval is performed is higher as a result of the cost comparison;
generating a second index which satisfies only the retrieval condition by using the first index, if the first index which satisfies the wider condition exists; and
retrieving a database by using the generated second index.

12. A computer-readable storage medium on which is recorded a program for causing a computer to execute a process when being used by the computer, said process comprising:
making a comparison between a cost required when retrieval is performed after an index corresponding to a retrieval condition is generated and a cost required when entire retrieval is performed;
determining whether or not two or more indexes which satisfy the retrieval condition by being combined exist among a plurality of already generated indexes, if the cost required when the entire retrieval is performed is higher as a result of the cost comparison;
generating an index corresponding to the retrieval condition by combining the two or more indexes, if the two or more indexes exist; and
retrieving a database by using the generated index.

13. A database retrieving apparatus, comprising:
an access process optimizing unit making a comparison between a cost required when retrieval is performed after an index corresponding to a retrieval condition is generated and a cost required when entire retrieval is performed;
a dynamic index generating unit generating an index corresponding to the retrieval condition if the cost required when the entire retrieval is performed is higher as a result of the cost comparison; and
an access processing unit retrieving a database by using the generated index.

14. A database retrieving apparatus, comprising:
an access process optimizing unit making a comparison between a cost required when retrieval is performed after an index corresponding to a retrieval condition is generated and a cost required when entire retrieval is performed;
an index managing unit determining whether or not a first index which satisfies a condition wider than the retrieval condition exists among already generated indexes, if the cost required when the entire retrieval is performed is higher as a result of the cost comparison;
a dynamic index generating unit generating a second index which satisfies only the retrieval condition by using the first index, if the first index which satisfies the wider condition exists; and
an access processing unit retrieving a database by using the generated second index.

15. A database retrieving apparatus, comprising:
an access process optimizing unit making a comparison between a cost required when retrieval is performed after an index corresponding to a retrieval condition is generated and a cost required when entire retrieval is performed;
an index managing unit determining whether or not two or more indexes which satisfy the retrieval condition by being combined exist among a plurality of already generated indexes, if the cost required when the entire retrieval is performed is higher as a result of the cost comparison;
a dynamic index generating unit generating an index corresponding to the retrieval condition by combining the two or more indexes, if the two or more indexes exist; and
an access processing unit retrieving a database by using the generated index.

16. A database retrieving apparatus, comprising:
access process optimizing means for making a comparison between a cost required when retrieval is performed after an index corresponding to a retrieval condition is generated and a cost required when entire retrieval is performed;
dynamic index generating means for generating an index corresponding to the retrieval condition if the cost required when the entire retrieval is performed is higher as a result of the cost comparison; and
access processing means for retrieving a database by using the generated index.
